(19) United States
(12) Patent Application Publication
(10) Pub. No.: US 2022/0296027 A1
(43) Pub. Date: Sep. 22, 2022

(54) COOKING DEVICE

(71) Applicant: BREVILLE PTY LIMITED, Alexanderia (AU)

(72) Inventors: Lichan MENG, Alexandria (AU); Brendan John FOXLEE, Alexandria (AU); David GARGIULO, Alexandria (AU)

(21) Appl. No.: 17/636,620

(22) PCT Filed: Aug. 20, 2020
(86) PCT No.: PCT/AU2020/050865

§ 371 Date: Feb. 18, 2022

(30) Foreign Application Priority Data
Aug. 20, 2019 (AU) 2019903026

(51) Int. Cl. A47J 27/00; H05B 1/02; H05B 6/06

(52) U.S. Cl. CPC A47J 27/004; H05B 1/0269; H05B 6/062

(57) ABSTRACT

A cooking device comprising: one or more heating elements for heating a fluid; and a control system configured to: control the one or more heating elements for a first period of time in order to heat the fluid to a first temperature; control the one or more heating elements for a second period of time such that the temperature of the fluid falls to a second temperature; and control the one or more heating elements for a third period of time to increase power supplied to the one or more heating elements relative to power supplied to the one or more heating elements during the second period of time.

### TECHNICAL FIELD

The present invention relates generally to a cooking device.

### BACKGROUND

Typically, a cooking device (e.g., a slow cooker, pressure cooker, rice cooker, induction cooker, sous vide device) can be configured to function by heating a vessel to a set point temperature for a period of time until the cooking device is powered off. Such a heating method allows a user to leave the cooking device unattended. For example, the user can activate the cooking device at 7 am to cook for 6 hours and leave for work as dictated by the recipe. However, by the time the user comes back from work, for example by 4 pm, the ingredients may not be cooked as desired due to the food item being cooked at the set point temperature for an extended period of time.

Some cooking devices use a standalone timer to delay cooking for an initial stage. However, ingredients may deteriorate in this stage. For example, delaying the cooking of chicken in an unrefrigerated environment such as the vessel may cause the chicken to spoil faster due to the high growth rate of food poisoning bacteria at room temperature.

### SUMMARY

It is an object of the present invention to substantially overcome, or at least ameliorate, one or more disadvantages of existing arrangements.

According to one aspect of the present disclosure, there is provided one or more heating elements for heating a fluid; and a control system configured to: control the one or more heating elements for a first period of time in order to heat the fluid to a first temperature; control the one or more heating elements for a second period of time such that the temperature of the fluid falls to a second temperature; and control the one or more heating elements for a third period of time to increase power supplied to the one or more heating elements relative to power supplied to the one or more heating elements during the second period of time.

According to another aspect of the present disclosure, there is provided a control system of a cooking device, the cooking device comprising one or more heating elements for heating a fluid, wherein the control system is configured to: control the one or more heating elements for a first period of time in order to heat the fluid to a first temperature; control the one or more heating elements for a second period of time such that the temperature of the fluid falls to a second temperature; and control the one or more heating elements for a third period of time to increase power supplied to the one or more heating elements relative to power supplied to the one or more heating elements during the second period of time.

According to another aspect of the present disclosure, there is provided a method of controlling a cooking device, the cooking device comprising one or more heating elements for heating a fluid, the method comprising: controlling the one or more heating elements for a first period of time in order to heat the fluid to a first temperature; controlling the one or more heating elements for a second period of time such that the temperature of the fluid falls to a second temperature; and controlling the one or more heating elements for a third period of time to increase power supplied to the one or more heating elements relative to power supplied to the one or more heating elements during the second period of time.

### BRIEF DESCRIPTION OF THE DRAWINGS

Preferred embodiments of the present invention will now be described, by way of example only, with reference to the accompanying drawings, in which:

FIG. 1 is a schematic block diagram of an example cooking device;

FIGS. 2A and 2B form a schematic block diagram of another example cooking device;

FIG. 3A is a cross-sectional view of an implementation of the example cooking device of FIGS. 2A and 2B;

FIG. 3B is a cross-sectional view of another implementation of the example cooking device of FIGS. 2A and 2B;

FIG. 4 is a perspective view of yet another implementation of the example cooking device of FIGS. 2A and 2B;

FIG. 5A is a flow chart of an example method performed by the example cooking device of FIG. 1;

FIG. 5B is an example temperature profile used for the example method of FIG. 5A;

FIG. 6A is a flow chart of an example method performed by the example cooking device of FIGS. 2A and 2B;

FIG. 6B is an example temperature profile used for the example method of FIG. 6A;

FIG. 6C is another example temperature profile used for the example method of FIG. 6A;

FIG. 7 is a schematic view of a predictive cooking system in which some embodiments according to the present technology can be implemented;

FIG. 8A is a perspective view of an example cooking device which can be implemented in the predictive cooking system of FIG. 7;

FIG. 8B is a front view of the example cooking device of FIG. 8A;

FIG. 9 is a flow diagram showing an example method of operation of a processor-based predictive cooking system according to some implementations of the present technology;

FIG. 10 is a flow diagram showing an example method of operation for determining a cooking program according to some implementations of the present technology;

FIG. 11 is a flow diagram showing a representative method of operation of a processor-based predictive cooking system according to some implementations of the present technology;

FIG. 12A is a graph showing temperatures over time for a fluid bath and a core temperature of a food item during traditional and predictive cooking processes;

FIG. 12B is a graph showing power input over time to a heater corresponding to the cooking temperatures shown in FIG. 12A;

FIG. 13 is an illustration of a representative application user input interface;

FIG. 14 is an illustration of a representative application status interface;

FIG. 15 is a block diagram illustrating an overview of devices on which some implementations can operate;

FIG. 16 is a block diagram illustrating an overview of an environment in which some implementations can operate;

FIG. 17 is a block diagram illustrating components which, in some implementations, can be used in a system employing the disclosed technology; and

FIG. 18 is an isometric view of an alternative representative cooking device.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

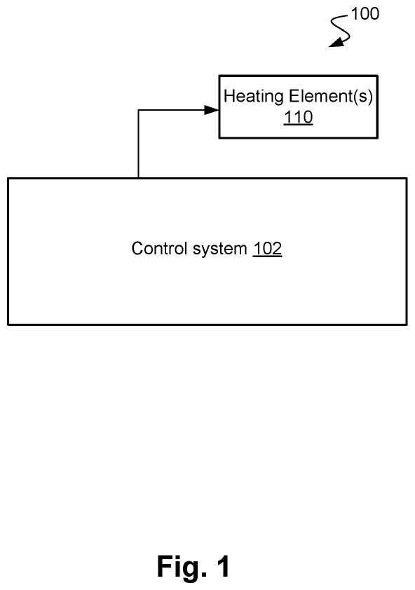

Referring to FIG. 1, a schematic block diagram of an example cooking device 100 is shown. The cooking device 100 comprises a control system 102 and one or more heating elements 110. The control system 102 is configured to control the one or more heating elements 110 to heat a fluid.

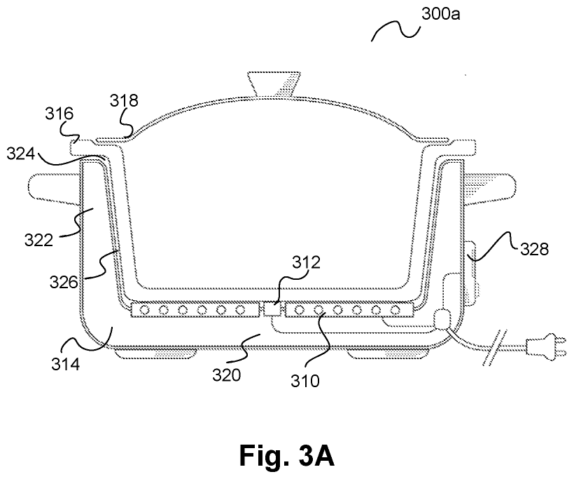

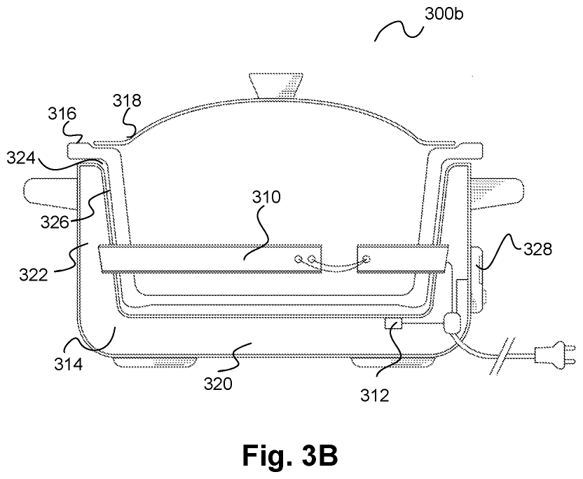

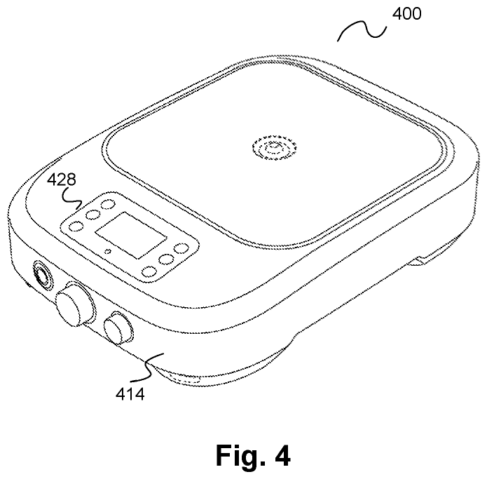

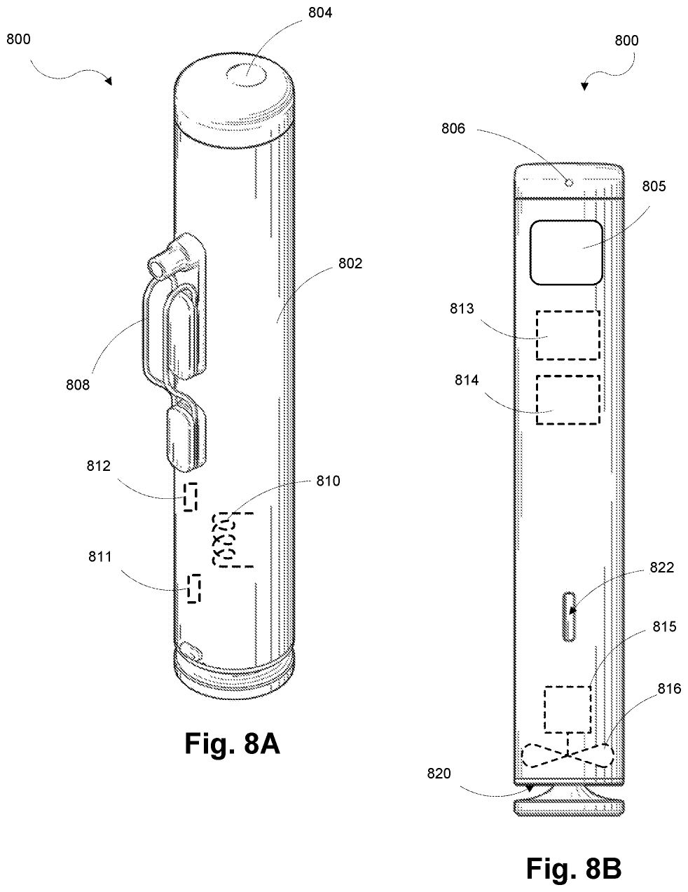

In some implementations, the cooking device 100 is a vessel cooker 300a or 300b comprising a vessel (e.g., a slow cooker, pressure cooker, rice cooker, or the like), as shown in FIGS. 3A and 3B. In other implementations, the cooking device 100 does not include a vessel (e.g., an induction cooker 400 as shown in FIG. 4 or a sous vide device as shown in FIGS. 8A and 8B).

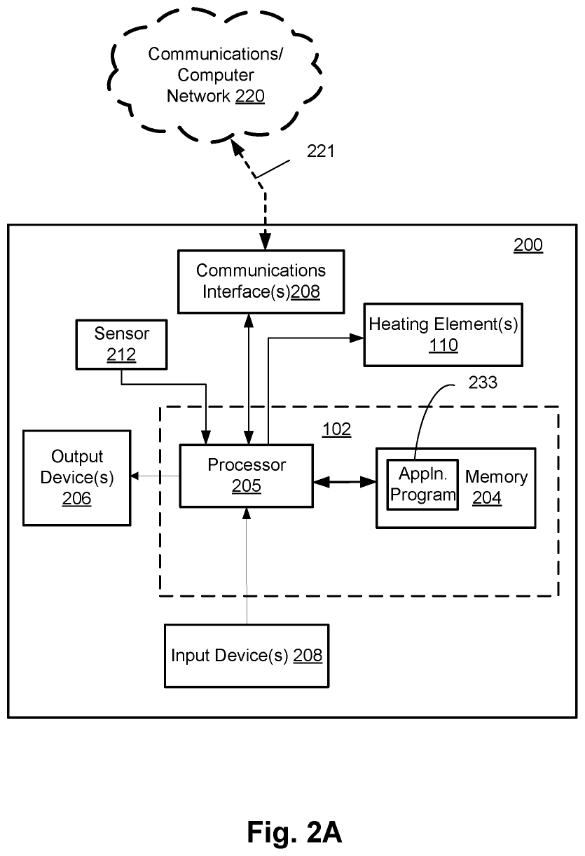

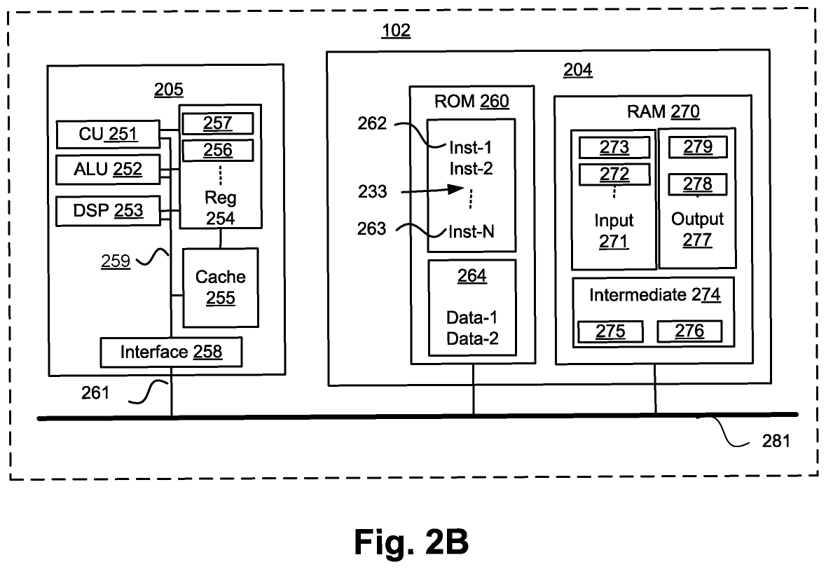

FIGS. 2A and 2B collectively form a schematic block diagram of another example cooking device 200 corresponding to the cooking device 100 of FIG. 1. As shown in FIG. 2A, the cooking device 200 includes the control system 102 and the one or more heating elements 110 of FIG. 1. Additionally, the cooking device 200 includes at least one output device 206, at least one input device 208 and a sensor 212. The sensor 212 detects the temperature of a fluid and transmits a signal representing the detected temperature to the control system 102. In some configurations, the control system 102 is configured to control the one or more heating elements 110 based at least in part on the signal received from the sensor 212. The fluid may be a liquid held in a vessel. The vessel can be a component of the cooking device 200. Alternatively, the vessel can be an separate component to the cooking device.

In the present example, the control system 102 comprises a memory 204 and a processing unit (or processor) 205 which is bi-directionally coupled to the memory 204. The memory 204 may be formed from non-volatile semiconductor read only memory (ROM) 260 and semiconductor random access memory (RAM) 270, as shown in FIG. 2B. The RAM 270 may be volatile, non-volatile or a combination of volatile and non-volatile memory. Whilst the control system 102 is described hereinafter as having the processor 205 and memory 204, the control system 102 could also be implemented by various other types of controls, for example, electrical circuits comprising a number of electrical components (e.g., resistors, inductors, capacitors, switches).

The output device 206 presents information (e.g., recipe selected, cooking status, remaining cooking time) to a user in accordance with signals received from the control system 102. Examples of output device 206 include display devices, for example, a liquid crystal display (LCD) panel, and sound making elements.

The input device 208 receives user settings from a user. Through manipulation of the input device 208, a user can set input information such as power level, recipe, cooking time and extended cooking time by which the user wishes the cooking to be finished. Examples of the input device 208 include touch sensitive panel physically associated with a display device to collectively form a touch-screen, as shown in FIGS. 3A, 3B and 4. Such a touch-screen may thus operate as one form of graphical user interface (GUI). Other forms of input device may also be used, such as press buttons, dials or rotary knobs used together with the display as shown in FIG. 4.

The cooking device 200 can also include a communications interface 208 to permit wireless communication with a computer (e.g., a mobile phone, tablet, laptop or the like) or communications network 220 via a connection 221. The computer is configured to control the cooking device 200 via the connection 221. The cooking device 200 is configured to receive one or more control commands from the computer, wherein the cooking device 200 operates according to the received one or more commands. The connection 221 may be wired or wireless. For example, the connection 221 may use radio frequency spectrum or optical spectrum. An example of a wired connection includes Ethernet. Further, examples of wireless connection include protocols based on standards of the IEEE 802 family (e.g., Wi-Fi IEEE 802.11; Zigbee IEEE 802.15.4), Bluetooth, Infrared Data Association (IrDa), LoRa, or the like.

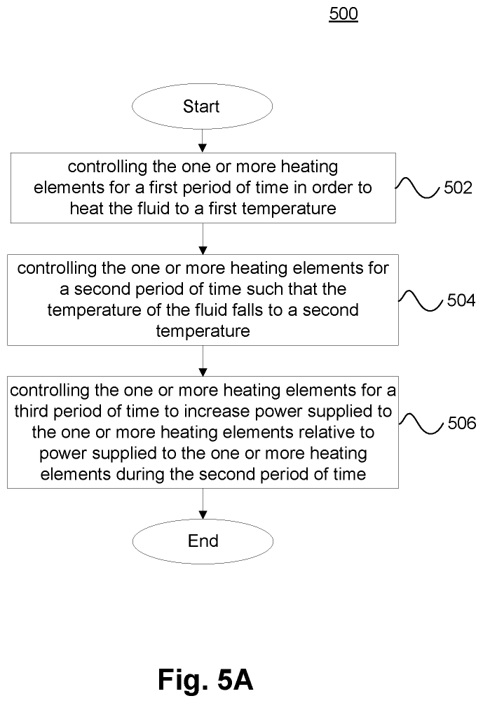

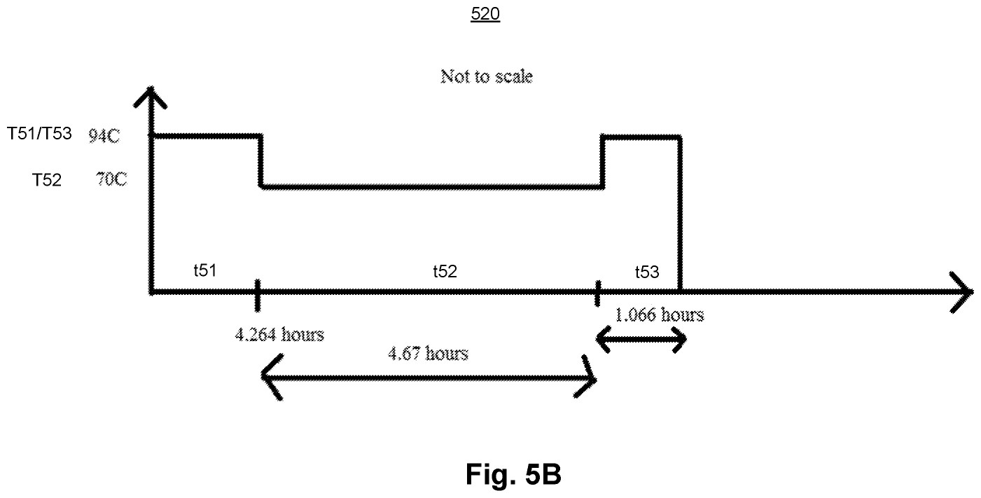

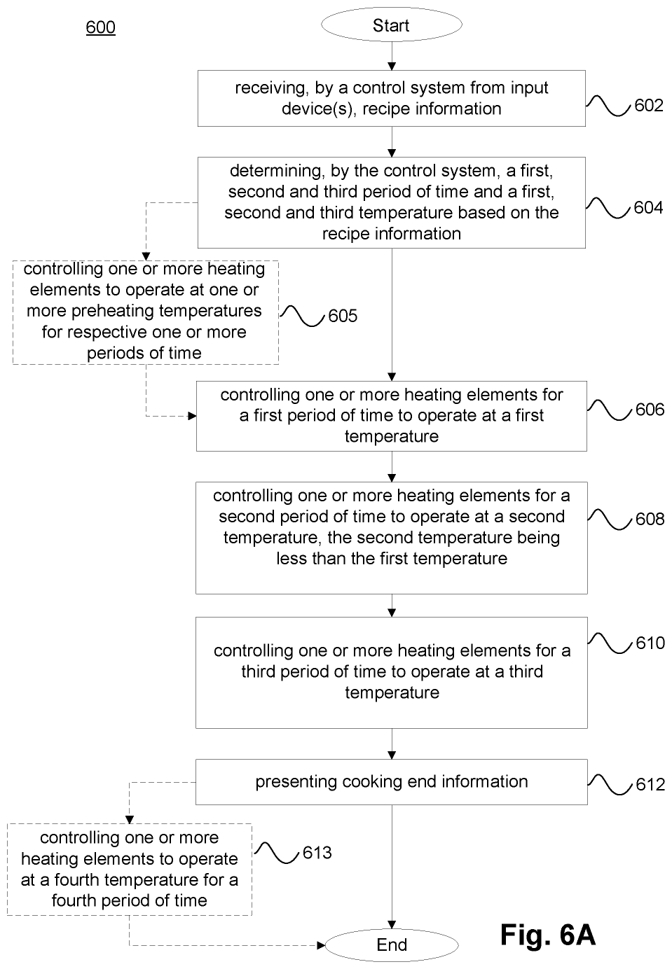

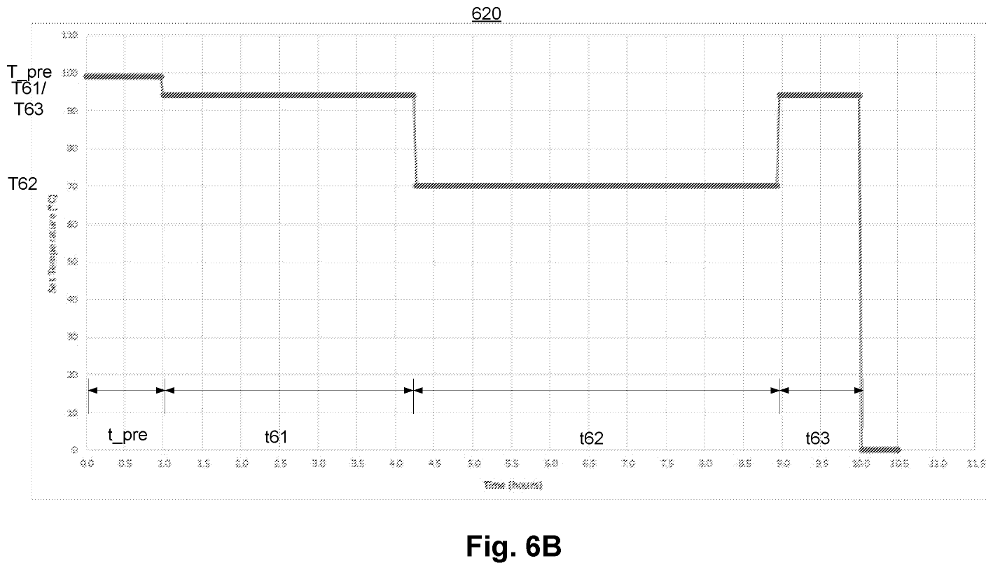

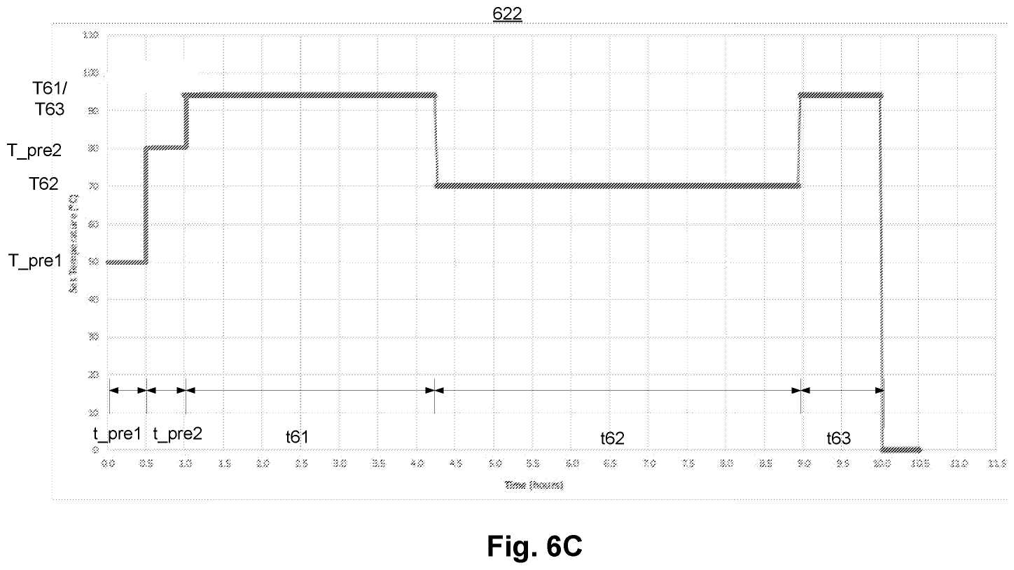

The methods described hereinafter may be implemented using the control system 102, where the processes of FIGS. 5A and 6A may be implemented as one or more software application programs executable within the control system 102. In particular, with reference to FIG. 2B, the steps of the described methods are affected by instructions in the software 233 that are carried out within the control system 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 233 of the control system 102 is typically stored in the non-volatile ROM 260 of the memory 204. The software 233 stored in the ROM 260 can be updated when required from a computer readable medium. The software 233 can be loaded into and executed by the processor 205. In some instances, the processor 205 may execute software instructions that are located in RAM 270. Software instructions may be loaded into the RAM 270 by the processor 205 initiating a copy of one or more code modules from ROM 260 into RAM 270. Alternatively, the software instructions of one or more code modules may be pre-installed in a non-volatile region of RAM 270 by a manufacturer. After one or more code modules have been located in RAM 270, the processor 205 may execute software instructions of the one or more code modules.

FIG. 2B illustrates in detail the control system 102 having the processor 205 for executing the application programs 233 and the memory 204. The memory 204 comprises read only memory (ROM) 260 and random access memory (RAM) 270. The processor 205 is able to execute the application programs 233 stored in one or both of the connected memories 260 and 270. When the cooking device 200 is initially powered up, a system program resident in the ROM 260 is executed. The application program permanently stored in the ROM 260 is sometimes referred to as “firmware”. Execution of the firmware by the processor 205 may fulfil various functions, including processor management, memory management, device management, storage management and user interface.

The processor 205 typically includes a number of functional modules including a control unit (CU) 251, an arithmetic logic unit (ALU) 252, a digital signal processor (DSP) 253 and a local or internal memory comprising a set of registers 254 which typically contain atomic data elements 256, 257, along with internal buffer or cache memory 255. One or more internal buses 259 interconnect these functional modules. The processor 205 typically also has one or more interfaces 258 for communicating with external devices via system bus 281, using a connection 261.

The application program 233 includes a sequence of instructions 262 through 263 that may include conditional branch and loop instructions. The program 233 may also include data, which is used in execution of the program 233. This data may be stored as part of the instruction or in a separate location 264 within the ROM 260 or RAM 270.

In general, the processor 205 is given a set of instructions, which are executed therein. This set of instructions may be organised into blocks, which perform specific tasks or handle specific events that occur in the cooking device 200. Typically, the application program 233 waits for events and subsequently executes the block of code associated with that event. Events may be triggered in response to input from a user, via the input device 208 of FIG. 2A, as detected by the processor 205. Events may also be triggered in response to other sensors and interfaces in the cooking device 200.

The execution of a set of the instructions may require numeric variables to be read and modified. Such numeric variables are stored in the RAM 270. The disclosed method uses input variables 271 that are stored in known locations 272, 273 in the memory 270. The input variables 271 are processed to produce output variables 277 that are stored in known locations 278, 279 in the memory 270. Intermediate variables 274 may be stored in additional memory locations in locations 275, 276 of the RAM 270. Alternatively, some intermediate variables may only exist in the registers 254 of the processor 205.

The execution of a sequence of instructions can be achieved in the processor 205 by repeated application of a fetch-execute cycle. The control unit 251 of the processor 205 maintains a register called the program counter, which contains the address in ROM 260 or RAM 270 of the next instruction to be executed. At the start of the fetch execute cycle, the contents of the memory address indexed by the program counter is loaded into the control unit 251. The instruction thus loaded controls the subsequent operation of the processor 205, causing for example, data to be loaded from ROM memory 260 into processor registers 254, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 233, and is performed by repeated execution of a fetch-execute cycle in the processor 205 or similar programmatic operation of other independent processor blocks in the cooking device 200.

FIG. 3A shows a cross-sectional view of an implementation of the cooking device 200. In the present implementation, the cooking device is a slow cooker 300a. However, the cooking device can also be various other types of cookers such as a pressure cooker or a rice cooker. The cooker 300a includes a base 314, a vessel 316 configured to hold the fluid, and a lid 318. The base 314 has a bottom portion 320 and a side wall portion 322 extending upwardly from the bottom portion 320 to an opening 324 so as to define a space 326. The vessel 316 is removably received in the space 326.

The cooker 300a comprises one or more heating elements 310 for heating the fluid. The one of more heating elements 310 relate to the heating elements 110 of FIG. 1. In the present arrangement, the one or more heating elements 310 are attached to the bottom portion 320. In an alternative arrangement, the one or more heating elements 310 are attached to the side wall portion 322, as shown for cooker 300b in FIG. 3B.

The cooker 300a comprises a control interface 328 and a sensor 312. The sensor 312 is attached to the base 314 and is configured to detect the temperature of the fluid and transmit a signal representing the detected temperature to the control interface 328. The control interface 328 includes the control system 102, and at least in part the input device 208 and the output device 206 of FIG. 2A. The control interface 328 is coupled to the sensor 312 and the one or more heating elements 310, and is configured to receive the signal transmitted by the sensor 312 and control the one of more heating elements 310 to heat the fluid based on the received signal.

FIG. 3B shows a cross-sectional view of another implementation 300b of the example cooking device 200.

FIG. 4 shows a perspective view of another implementation of the cooking device 200. In the present implementation, the cooking device is an induction cooker 400. The induction cooker 400 includes a base 414 and a control interface 428. In the example of FIG. 4, a vessel (not illustrated) is provided on the base 414 to hold the fluid. The control interface 428 includes the control system 102, and at least in part the input device 208 and the output device 206 of FIG. 2A. The base 414 includes one or more heating elements (not illustrated) for heating the fluid. The base 414 further includes a sensor (not illustrated) for detecting the temperature of the fluid and transmitting a signal representative of the detected temperature to the control interface 428.

FIG. 5A shows an example method 500 performed by the cooking device 100. In the present example, the cooking device can be a slow cooker including a vessel configured to hold the fluid. However, the cooking device can also be various other types of vessel cooker such as a pressure cooker or a rice cooker. The cooking device can also be an induction cooker, or a sous vide device that does not include a vessel. The cooking device 100 performs cooking in accordance with a temperature profile including three stages, for example a temperature profile 520 as shown in FIG. 5B. In each stage, the control system 102 controls the one or more heating elements 110 to operate at a particular temperature for a particular period of time. The method 500 starts at step 502. At step 502, control the one or more heating elements 110 for a first period of time t51 in order to heat the fluid to a first temperature T51. For ingredients such as meat, temperature T51 could be, for example, 94° C. The method 500 continues from step 502 to step 504. At step 504, the control system 102 controls the one or more heating elements 110 for a second period t52 of time such that the temperature of the fluid falls to a second temperature T52. The second temperature T52 is less than the first temperature T51. For ingredients such as meat, temperature T52 could be, for example, 70° C. It will be appreciated throughout examples discussed herein that controlling the one or more heating elements 110 during this second period of time may mean providing less power to the one or more heating elements compared to the first period of time, or in some instance providing no power to the one or more heating elements during the second period of time. The method 500 continues from step 504 to step 506. At step 506, the control system 102 controls the one or more heating elements 110 for a third period of time t53 to increase power supplied to the one or more heating elements 110 relative to power supplied to the one or more heating elements 110 during the second period of time t52. In some instances, this can result in increasing the temperature of the fluid to a third temperature T53, wherein the third temperature T53 is greater than the second temperature T52. For ingredients such as meat, temperature T53 could be, for example, 94° C. In other instances, the increase in power supplied to the one or more heating elements 110 can result in maintaining the temperature of the fluid at T52. The method 500 ends at step 506. Different temperatures and periods of time could be used depending on the type of ingredients, the selection of recipe, and/or the type of cooking method utilised.

Referring to FIG. 5B, an example temperature profile 520 is shown. In the example of FIG. 5B, the first, second, and third temperatures T51, T52 and T53 are 94° C., 70° C., and 94° C., respectively, while the first, second, and third periods of time t51, t52, and t53 are 4.264 hours, 4.67 hours, and 1.066 hours, respectively.

FIG. 6A shows an example method 600 performed by the cooking device 200. In the present example, the cooking device is a slow cooker including a vessel for holding the fluid. However, the cooking device can also be various other types of cooker such as a pressure cooker and a rice cooker. The cooking device can also be an induction cooker or sous vide device that does not include a vessel. The cooking device 200 performs cooking in accordance with a temperature profile, for example a temperature profile 620 as shown in FIG. 6B. The method 600 starts at step 602. At step 602, the at least one input device 208 receives input information indicative of, for example, a recipe from a user which is transferred to the control system 102. The input information can include, for example, an original cooking time and optionally an extended cooking time by which the user wishes the cooking to be finished. The maximum extendable cooking time could be limited, for example to 12 hours. In other arrangements, the input information includes a selection of a recipe associated with an original cooking time. The at least one input device 208 is, for example, a dial, a number of press buttons, a touch-screen, or a combination thereof.

In an alternative implementation, the control system 102 receives the input information via the communications network 220 from a user device (e.g., a mobile phone, a tablet or the like).

The method 600 continues from step 602 to step 604. At step 604, the control system 102 determines a first, second and third period of time t61, t62, and t63 and a first, second and third temperature T61, T62, and T63, based on the input information received. In one implementation, the control system 102 may use a lookup table stored in the memory 204 based on the original and extended cooking times to determine the first, second and third periods of time t61, t62, and t63 and the first, second, third temperatures T61, T62, and T63. The second temperature T62 is less than the first temperature T61. The third temperature T63 is greater than the second temperature T62. The sum of the first period of time t61 and the third period of time t63 is not greater than the original cooking time while the sum of the first, second and third periods of time t61, t62 and t63 is equal to the extended cooking time. Different temperatures and periods of time could be used depending on the type of ingredients or the selection of recipe.

The method 600 continues from step 604 to step 606. At step 606, the control system 102 control the one or more heating elements for a first period of time t61 in order to heat the fluid to the first temperature T61. The method 600 continues from step 606 to step 608. At step 608, the control system 102 controls the one or more heating elements 110 for a second period of time t62 in order to heat the fluid to the second temperature T62. The method 600 continues from step 504 to step 506. At step 506, the control system 102 controls the one or more heating elements 110 for a third period of time t63 in order to heat the fluid to the third temperature. The method continues from step 610 to step 612. At step 612, cooking end information is presented by the output device 206 to the user and the method 600 ends.

In another arrangement, the method 600 comprises an additional pre-heating step 605. In the present arrangement, step 604 enters the pre-heating step 605 before proceeding to step 606. At step 605, the control system 102 controls the one or more heating elements 110 to operate at one or more preheating temperatures T_pre for respective one or more time periods. For example, as shown in FIG. 6B, the control system 102 controls the one or more heating elements 110 to preheat the fluid to a temperature T_pre for a period of time t_pre. Whilst the temperature T_pre has been described as having a constant value, the temperature T_pre can also be configured to have a step value or be a series of step values associated with respective time periods, as shown in FIG. 6C, for example. In particular, the one or more pre-heating temperatures can include T_pre1 and T_pre2 which are maintained for respective time periods t_pre1 and t_pre2. The method 600 then continues from step 605 to step 606.

In yet another arraignment, the method 600 comprises an additional keep-warm step 613. In the present arrangement, step 612 continues to the keep-warm step 613. At step 613, the control system 102 controls the one or more heating elements 110 to operate at a fourth temperature T4 for a fourth period of time t4 or until the cooking device 200 is powered off. The method 600 ends at step 613.

Referring to FIG. 6B, an example temperature profile 620 is shown. In the example of FIG. 6B, the original cooking time is for example 6 hours, while the extended cooking time is for example 10 hours. The pre-heat, first, second, and third temperatures T_pre, T61, T62, and T63 are 99° C., 94° C., 70° C., and 94° C., respectively, while the pre-heat, first, second, and third periods of time t_pre, t61, t62, and t63 are 1 hour, 4.264 hours, 4.67 hours, and 1.066 hours, respectively.

Referring to FIG. 6C, another example temperature profile 622 is shown. In the example of FIG. 6C, the original cooking time is for example 6 hours, while the extended cooking time is for example 10 hours. The pre-heat, first, second, and third temperatures T_pre1, T_pre2, T61, T62, and T63 are 50° C., 80° C., 94° C., 70° C., and 94° C., respectively, while the pre-heat, first, second, and third periods of time t_pre1, t_pre2, t61, t62, and t63 are 0.5 hours, 0.5 hours, 4.264 hours, 4.67 hours, and 1.066 hours, respectively.

In an example use case of the arrangements described above, a user may wish to start cooking at 12 pm and leave for work, but wants to have the cooking finished by 10 pm when the user comes back home. Through the arrangements described, for example the cooking device 200 described, the user can operate the input device 208 to set an original cooking time to be, for example, 6 hours, or select a recipe associated with a original cooking time of, for example, 6 hours. The user can further operate the input device 208 to set an extended cooking time to be, for example, 10 hours. The input information of the original cooking time of 6 hours and the extended cooking time of 10 hours are transferred to the control system 102 (e.g., at step 602). The control system 102 determines a first, second, and third period of time and a first, second, and third temperature based on the input information (e.g., at step 604), wherein the second temperature is less than the first temperature and the third temperature is greater than the second temperature. The cooking device 200 then cooks for 10 hours by controlling the one or more heating elements 110 to operate at the first temperature for the first period of time (e.g., at step 606) to heat the fluid, then operate at a second temperature for the second period of time (e.g., at step 608), and then operate at the third temperature for the third period of time (e.g., at step 610). The arrangements described allow ingredients to be cooked without having to be left at temperatures in which food poisoning bacteria grow rapidly. In addition, having an intermediate stage of cooking at a second temperature that is less than a first temperature and a third temperature in the cooking process allows an extended cooking process without overcooking the ingredients.

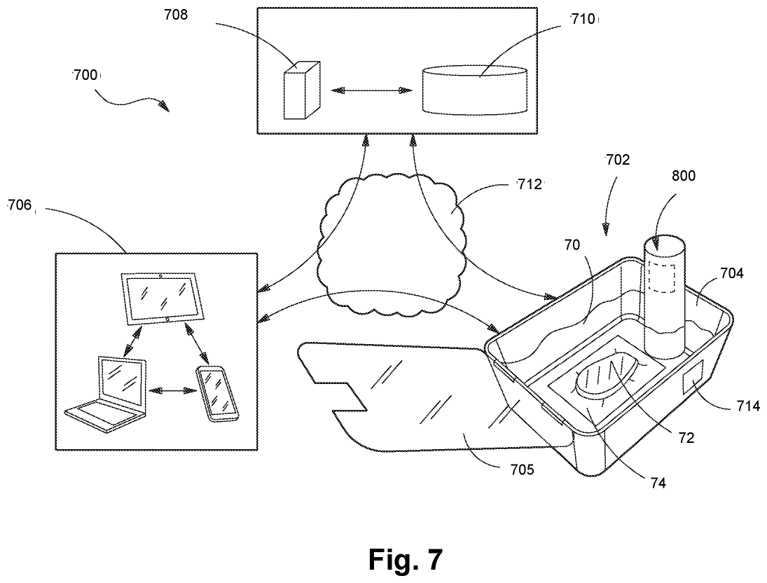

FIG. 7 illustrates a schematic view of a predictive cooking system 700 on which some embodiments according to the present technology can be implemented. The predictive cooking system 700 can include a cooking appliance 702, one or more processors 708, and one or more memory devices 710 communicatively coupled together via one or more communication channels, such as communication networks 712. A client computing device 706 can communicate with the system 700 via the communications networks 712 to provide input to the system. For example, a user can use the client computing device 706 to provide a desired food temperature, an acceptable temperature gradient across the food item, food item characteristics (e.g., type, weight, thickness, shape) and container information related to container characteristics (e.g., size, shape, volume).

The cooking appliance 702 can include a container 704 filled with a fluid 70, such as water, and a cooking device 800, such as a thermal immersion circulator or sous vide device, at least partially submerged in the fluid 70. In some implementations, the cooking appliance 702 can include an information label 714 and a lid 705 configured to cover the container 704 in order to help control heat loss and evaporation of the liquid 70. In the illustrated example, a food item 72, such as a steak, can be placed in a resealable plastic bag 74 and placed in the liquid 70. As the cooking device 800 heats the liquid 70, the food item 72 can be cooked according to the predictive cooking methods disclosed herein. In other implementations, the cooking appliance 702 can comprise an oven, slow cooker or pressure cooker, for example. In these embodiments, the cooking appliance substantially incorporates the cooking device, in that an oven includes the container 704, being an oven cavity, filled with the fluid 70, being air and/or steam in the oven cavity. Other examples of cooking appliances that substantially incorporate the cooking device are convections ovens with humidity control, slow cookers or pressure cookers.

As shown in FIG. 8A, the cooking device 800 provided in the form of a sous vide device can include a housing 802 and a mounting clip 808 adapted to attach the cooking device 800 to the container 704 (FIG. 7). The housing 802 can contain a heater 810 and sensors, such as a temperature sensor 811, a pressure sensor 812, and/or a humidity sensor. In embodiments where the cooking device 800 includes the container 704, the cooking device 800 may include a second pressure sensor (not shown) to provide a container pressure measurement indicative of a pressure in the container 704. With further reference to FIG. 8B, the housing 802 can contain a motor 815 operatively coupled to an impeller 816 for circulating liquid 70 through inlet 820, across heater 810, and out a discharge outlet 822. The cooking device 800 can include a processor 813 and a memory device 814 (which may be monolithically integrated with the processor). The cooking device 800 can also include a control button 804 (e.g., on/off), an indicator light 806, and/or a user interface 805.

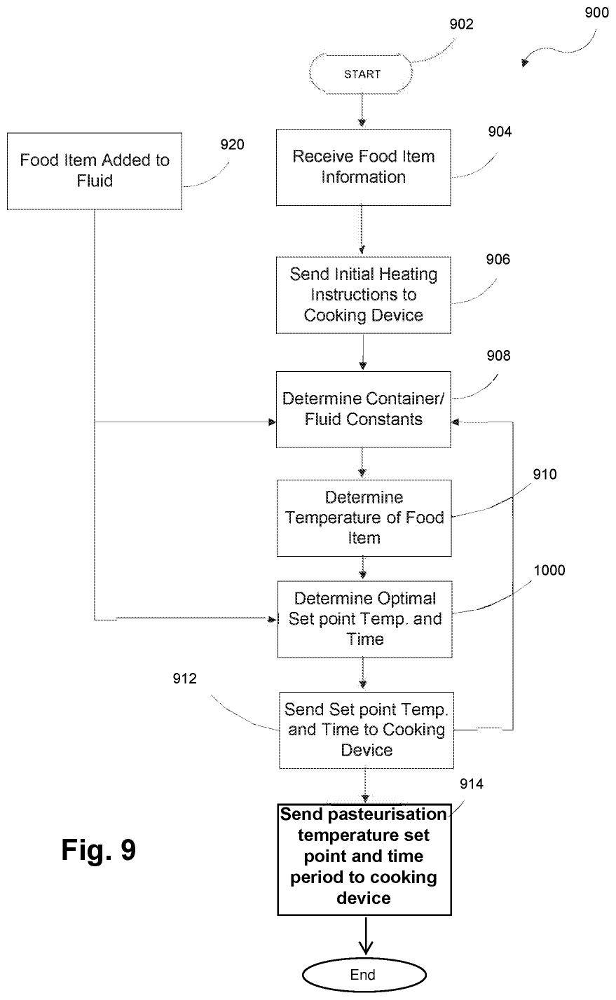

FIG. 9 is a flow diagram showing a method of operation 900 of the processor-based predictive cooking system according to some embodiments of the present technology. The method 900 starts at 902. For example, the method 900 can start in response to activation of a specific application on a client computing device 706 (FIG. 7) or via the control button 804 and/or user interface 805 of the cooking device 800 (FIGS. 8A and 8B).

At 904, the system receives information indicative of one or more characteristics of the food item 72. For example, in the case of meat (e.g., steak 72), the system can receive information related to species, cut, thickness, shape, weight, quantity, and the like. Although the devices, systems and methods are described herein with respect to preparing a meat food item, other types of foods can be prepared using the disclosed technology, such as fish, vegetables, puddings, and custards, to name a few.

At 906, the system sends initial heating instructions to the cooking device 800 in order to start heating the fluid 70 (FIG. 7) and obtaining measurements via the temperature and pressure sensors 811/812 (FIGS. 8A and 8B), for example. Alternatively, the initial heating instructions may be set by the user. In some implementations, the system can receive geographic location (e.g., GPS) information from the user device to estimate the atmospheric pressure based on an altitude of the geographic location rather than or in addition to the pressure sensor 812 (FIG. 8A). In some implementations, the cooking device 800 includes a humidity sensor to provide a measurement of humidity in the container. In other implementations, the cooking device 800 includes a second pressure sensor to provide a container pressure measurement, as for implementations where the cooking device 800 incorporates the container, the pressure in the container may be different to the ambient pressure measured by the pressure sensor 812, or estimated on the basis of the geographic location information. A measurement of power delivered to the heater 810 (FIG. 8A) can also be determined using calculations based on current, voltage, and/or pulse width input to the cooking device. In some implementations, the initial heating instructions can be determined based on past measurements and calculations which can be used as a starting point to estimate the physical characteristics of the fluid 70 and the container 704 (FIG. 7), for example.

At 908, the system can determine one or more process parameters related to corresponding physical characteristics of the fluid 70 and the container 704 (FIG. 7) based on changes in temperature relative to the power delivered to the heater 810 (FIG. 8). The system can use least-squares, Kalman filter, or other similar mathematical methods for fitting a physical model to the measured data to estimate, or determine, the process parameters such as fluid mass/volume c₁, thermal conductivity of the container to the environment c₂, an offset c₃ that depends on air temperature and dew point, and an evaporation loss to the environment c₄ (referred to collectively as cᵢ). For example, in some implementations, the system can use the following physical model to determine the above constants related to corresponding physical characteristics of the fluid 70 and the container 704 (FIG. 7):

$$\frac{d T}{d t} \approx {c}_{1} ( P - F ) - {c}_{2} T + {c}_{3} - {c}_{4} H ( T ) \qquad Equation 1$$

where P (t) is the power delivered to the heater 810 as a function of time (t), F(t) is the energy going into the food item 72 as a function of time (t), T (t) is the fluid's temperature as a function of time (t), H(T(t)) is the specific humidity at the fluid's surface as a function of time (t), the cᵢ≥0 may change in time. This change in process parameters over time can be accomplished with a process noise in a sigma-point Kalman filter or with weights in a least-squares fit, for example. Note that c₁∝V_{fluid}⁻¹.

In some implementations, information related to the fluid 70 and the container 704 can be input by the user (FIG. 7). For example, the user could provide the dimensions of the container 704 (e.g., length, width, and/or height) and/or the container material, such as glass, metal, or insulated material. This information can be used to refine the physical model by replacing some process parameters with known process parameters. In some implementations, the characteristics of the container 704 can be known to the system and/or need only be identified by name, code number, or a bar code located on the container, for example, or predetermined by the manufacturer. The user can enter the name or code, or scan a bar code via camera from a label 714 positioned on the container 704 using a client computing device 706. The system can retrieve all necessary data from memory (e.g., memory 710) related to the identified container.

At 910, the system can approximate the temperature of the food item 72 with:

$$\frac{\partial τ}{\partial t} = α ( \frac{{\partial }^{2} τ}{\partial {r}^{2}} + \frac{β}{r} \frac{\partial τ}{\partial r} ) \qquad Equation 2$$

$$τ ( r , {t}_{0} ) = {τ}_{0} , \frac{\partial τ}{\partial r} ( r = 0 , t ) = 0 \qquad Equation 3$$

$$k \frac{\partial τ}{\partial r} ( r = R , t ) = h [ T ( t ) - τ ( r = R , t ) ] , \qquad Equation 4$$

where τ(0≤r≤R, t≥t₀) is an estimate of the food's temperature, to is when the food is added, when cooking sous vide or in a slow cooker or pressure cooker. When cooking in an oven, additional terms are added to the right-hand side of Equation 4 to account for water vapor evaporating from and condensing on the food's surface. In particular, α=k/(ρcₚ) is thermal diffusivity, k is thermal conductivity, ρ is density, cₚ is specific heat, 2R is the characteristic thickness, 0≤R≤2 is the characteristic shape, h is surface heat transfer coefficient, and τ₀≈5° C. is the initial temperature. The constants α, k, β, cₚ are selected based on food type and cut. For example, whether the food item is beef or pork and whether it is a flank steak or a tenderloin. From the temperature distribution the system can estimate the change in energy of the food. Given a temperature profile and a β, the system performs a numerical integration or quadrature to estimate the energy. The characteristic shape β describes how heat is transferred from the boundaries of the food item and can vary from 0 to 2. If the food item is viewed relative to three axes (i.e., x, y, and z), values near zero indicate that the heat is coming from +/−x but not y or z, values near 1 indicate that the heat is coming from +/−x and +/−y but not z, and values near 2 indicate that the heat is coming from all directions, that is, β is representative of the characteristic dimensionality of the food item's heat transfer system, minus one.

In situations where multiple food items are to be cooked at the same time the system can use the average thickness and total, combined weight of the food items. In some implementations, the system assumes that all the items are approximately uniform. In other cases, if the items are of disparate shapes, the system can adjust the algorithm so it takes longer to heat so as to mitigate under- and overcooking.

In some implementations, the system can receive shape information related to the food item via the client device 706 (FIG. 7). For example, the client device's camera can be used to capture image date (e.g., via available augmented reality toolkits) which can be related to the food item's characteristic shape parameter β. The β parameter characterizes different shapes, namely plane, cylinder, and sphere/cube, with values ranging from 0 to 2, respectively. In some implementations, the system can draw a box around the food item such that the dimensions, e.g., x, y, z, of the box can be used to estimate the food item's characteristic shape parameter β.

In some implementations, the shape of the food item to be cooked can be matched with an image of a similar food item shape presented in a user application. In some implementations, the system can use deep learning from a database of labeled images for food item detection based on a photo of the food item to be cooked. In some implementations, image data technology can be used for determination of the fat content of a food item by using its average color (e.g., CIELAB color space) derived from a photo of the food item.

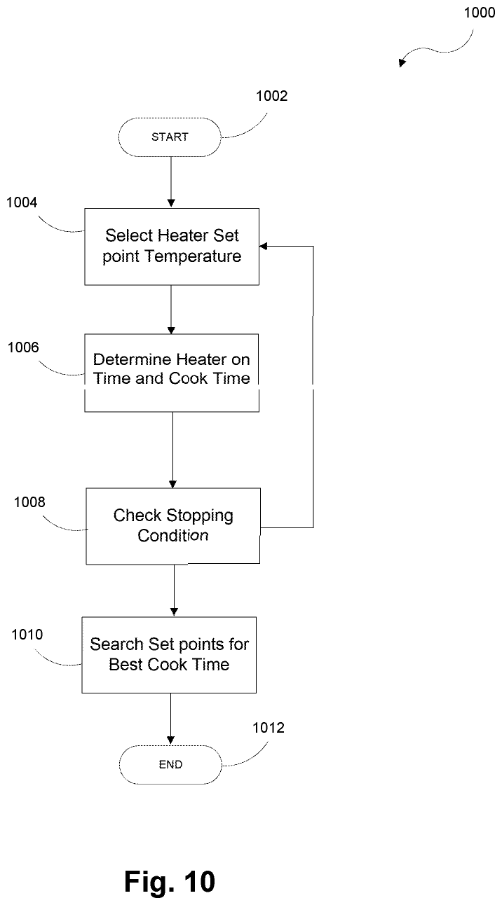

At 1000, the system can generate a cooking program (e.g., heater set point temperature and heater on time). The cooking program seeks to heat the core of the food item whilst maintain or subceeding a predetermined acceptable temperature gradient across the food item, violation of which would risk overcooking an exterior of the food when attempting to heat the core of the food. The system seeks to determine a set point temperature and heater operation period for generating the cooking program such that the food item substantially reaches the desired food temperature while maintaining or subceeding a predetermined acceptable temperature gradient across the food item, and, after the heater operation period, the fluid cools to substantially the desired food item temperature within a predetermined time period, and the food item substantially reaches the desired food temperature within the predetermined time period. This can be referred to as an aggressiveness constraint which informs how hot the edges of the food item can get. In some instances, the system can be configured to control the heater to a higher set point temperature at least for a brief amount of time to ensure pasteurization or sterilization is achieved. This process 1000 is more fully described below with reference to FIG. 10.

At 912, executable instructions (e.g., the cooking program) for controlling the heater can be sent to the cooking device, including heater control information related to a set point temperature and a heater operation period. Once the cooking program is sent to the cooking device the method can return to 908 to periodically (e.g., every 10-300 seconds) update the container/fluid process parameters, determine the food item temperature, and determine updated heater control information for the resulting cooking program. Due to heat losses from conduction through the container and evaporation from the surface of the fluid, the fluid heats up more slowly over time. Therefore, the system can periodically recalculate the set point temperature and heater operation period to account for changes in the cooking environment.

At 914, the system can control the heater to increase to a higher set point temperature for a period of time sufficient to ensure pasteurization or sterilization is achieved. In one form, this step may be performed automatically by the system. Alternatively, the system may receive an indication from a user via the client computing device 706 (FIG. 7) that the food item should be pasteurized or sterilized. The period of time to perform pasteurization or sterilization may be set in a table stored in memory of the system.

At 920 the food item can be added to the fluid before, during, or after the initial heating instructions are sent to the cooking device at 906. For example, the food item can be added to the fluid at 908 or 1000. The system can receive an indication from a user via the client computing device 706 that the user has added the food item to the fluid. In some implementations, the system can detect when the food item has been added by monitoring changes in the fluid temperature relative to the power delivered to the heater. For example, if the fluid temperature, as indicated by the temperature measurement, begins rising slower than previously determined it can be inferred that the food item has been added to the fluid. If a user adds the food item early, before the fluid reaches the set point temperature, the system can detect this and adapt accordingly. In some implementations the system uses a predictor-correct algorithm, to monitor deviance from the prediction to detect the addition of food and other user events (e.g., adding water).

FIG. 10 is a flow diagram showing a representative method 1000 for determining updated heater control information for the cooking program according to some embodiments of the present technology. The system predicts the outcomes of multiple temperature set points. The system can project the outcome of each set point temperature forward in time, solving the heat equation (e.g., Equation 2) at multiple time steps, thereby predicting the temperature profile of the food item and the heat energy added to the food item over time. A Kalman filter can be used to estimate the different heat flows to compute the fluid temperature at the next time step. In some implementations, a shooting method can be used to construct a valid cooking program that heats the core of the food item to the desired food temperature while maintaining or subceeding the acceptable temperature gradient constraints (e.g., aggressiveness factor). The fluid temperature of a valid cooking program will match the core temperature in a predetermined period of time within which the food item is first fully heated. In embodiments where the fluid is air, and the heat capacitance of the heating element exceeds that of the fluid, the heating element temperature of a valid cooking program will match the core temperature in a predetermined period of time within which the food item is first fully heated. Preferably, the predetermined period of time is between 10 to 300 s. The valid cooking programs can then be searched to obtain the cooking program with the shortest cooking time. In some implementations, the user can opt for a less evenly heated final product (e.g., higher temperature gradient and/or error in core temperature) to reduce the amount of time to cook the food item or for foods in which the predetermined acceptable temperature gradient should be higher for better culinary results. The system can provide feedback to the user to alert the user that reduced cooking time may impact the final characteristics of the food item.

At 1002, the method starts with measurements from how the fluid has heated during method of operation 900 (FIG. 9) and input from the user, as indicated above, including a desired food or core temperature, To, for the food item and an acceptable temperature gradient across the food item, that is from a surface to a core of the food item.

At 1004, the method selects a set point temperature for evaluation. The method includes searching over all possible temperature set points—the temperature the cooking device tries to heat the fluid to before, according to updated heater control information, cooling down to the user's desired food temperature, just as the food's core temperature comes up to that temperature.

At 1006, the method includes computing the heater operation period given the selected set point temperature. The heater operation period is the time at which the cooking device should change its set point from the initially selected set point temperature, which according to presently disclosed principles is generally higher than the desired food temperature T₀, to the desired temperature T₀. The method involves stepping the system state forward in time: at each step, determining the fluid temperature, fluid volume/mass, and the food item's temperature profile (using the determined fluid temperature).

In some implementations, the heater operation period can be estimated as the period of time until the food item's surface reaches a maximum value or the period of time until the food item's core reaches a predetermined threshold value. The food item will continue heating (e.g., carryover effect) after the set point temperature has been changed from the set point temperature down to the user's desired-food temperature due to the heat capacitance of the fluid and/or the heating element. This is accounted for as the heating or cooking time, which is usually longer than the heater operation period, and is when the food's core is estimated to be T₀−δ(δ=acceptable variation from desired core temperature). The algorithm seeks to optimize the heating time. In some implementations, the heating time can be estimated using a shooting method as discussed above.

At 1008, the algorithm might stop for several reasons. For example, the set point temperature used in the last step is within ε of the temperature set point that gives the best heating time. This ε might depend on the current state of the system or the estimate; for example, if the optimization is run every N seconds (e.g., 10-300 seconds) and the fluid will not reach T₀ within N seconds, then any set point temperature at or above To will produce the same result. Once a stopping condition is reached the optimization program returns to 1004 to evaluate another set point temperature.

At 1010, once all of the set point temperatures have been evaluated, the method includes searching the acceptable set point temperatures for the one with the best cooking time. The best cooking time can be a program that finishes within a user-selected period of time in the future or within a user-selected period of time of day. In some implementations, a binomial or bounded Newton's algorithm, a direct search algorithm, or a gradient based search algorithm can be used to search the set point temperatures to select the set point temperature that fulfils the optimized cooking program requirements. At 1012, once the best set point temperature is selected, the set point temperature and heater operation period are returned to method of operation 900 for communication to the cooking device at 912 (FIG. 9).

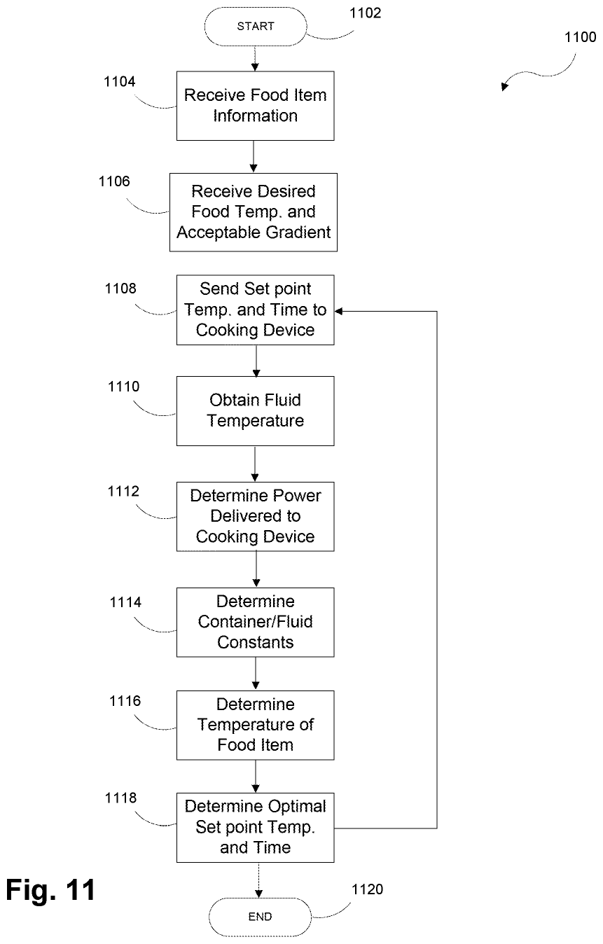

FIG. 11 is a flow diagram showing a representative method of operation 1100 of a processor-based predictive cooking system 700 according to some embodiments of the present technology. This method can be stored in any data storage device, e.g. a processor's on-chip memory, for the cooking device; alternatively, at least some of the method can be performed by the user device. The method can be applied to not only the device 800 but other cooking devices.

The method 1100 starts at 1102. For example, the method 1100 can start in response to activation of a specific application on a client computing device 706 (FIG. 7) or via the control button 804 and/or user interface 805 of the cooking device 800 (FIGS. 8A and 8B). At 1104 the system can receive information indicative of one or more characteristics of the food item 72 to be cooked (e.g. in the fluid 70). At 1106, the system can receive a desired food temperature and information related to a predetermined acceptable temperature gradient across the food item 72. At 1108, the system performs a process, including sending instructions for controlling the heater 810 (which could be a heater having a heating element positioned in a container of the fluid 70). The instructions can include information related to a set point temperature and a heater operation period. At 1110, a temperature measurement (e.g. of the fluid 70, and/or of the heater 810) can be obtained from a temperature sensor 811. At 1112, a measurement of power delivered to the heater 810 can be determined. At 1114, one or more constants related to one or more corresponding physical characteristics (e.g. of at least one of the fluid 70 and the container 704), based on at least one of the temperature measurement and the measurement of power, can be determined. At 1116, a food temperature of the food item 72 can be determined. At 1118, the set point temperature and the heater operation period can be determined by solving for, e.g., a fluid temperature that brings the food item 72 to the desired food temperature while maintaining or subceeding the predetermined acceptable temperature gradient across the food item 72 and that results, after the heater operation period, in the fluid 70 cooling to substantially the desired food temperature within a predetermined time period, and the food item 72 substantially reaches the desired food temperature within the predetermined period. The process, (e.g., 1108-1118) can be repeated one or more times until the food temperature reaches the desired food temperature at which point the method process 1100 ends at 1120.

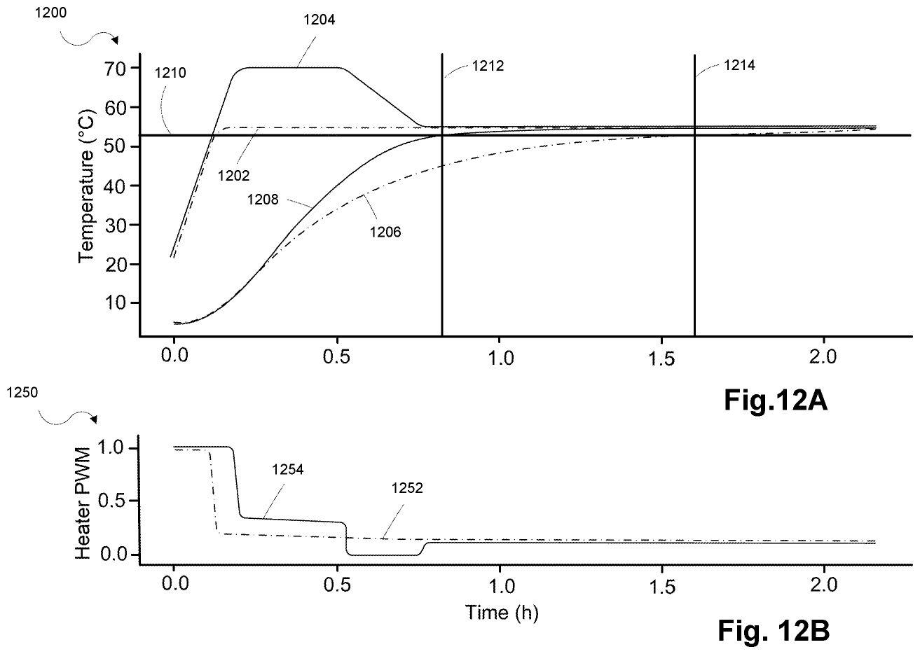

FIG. 12A is a graph 1200 showing temperatures over time for a fluid bath and a core temperature of a food item during traditional (dashed lines) and predictive (solid lines) cooking processes. In traditional sous vide cooking, the fluid temperature 1202 is ramped up to the set point (e.g., 55° C.) and held at that temperature at least until the food item 1206 reaches within e.g., 2° C. (line 1210) of that set point temperature, which is also the desired food temperature. In the illustrated example, this occurs in approximately 96 minutes (line 1214).

In contrast, using the disclosed predictive cooking technology, the fluid temperature 1204 can be ramped up to well above the traditional set point temperature (e.g. first stage). In the illustrated example, the fluid temperature 1204 can be raised to approximately 70° C. The fluid is held at that temperature for the heater operation period, in this case until approximately 30 minutes has elapsed, at which point the heater is turned off and the fluid is allowed to cool. The heater remains off and the fluid cools until the fluid temperature falls to the desired food temperature. Using the disclosed predictive cooking techniques, the fluid substantially reaches the desired food temperature within a predetermined period of time (i.e. second period of time), and the food item 1208 substantially reaches the desired food temperature within the predetermined period of time. In the illustrated example, the predetermined period of time occurs in approximately 50 minutes (line 1212), which is approximately half the time of the traditional technique. At this point, the heater can be turned back on thereby increasing the electrical power provided to the heater in order to maintain the fluid and food item at the desired food temperature until the user is ready to serve the food and/or to pasteurize the food item. It will be appreciated that the food may be maintained at the desired food temperature after the normal cooking time but the overall extended cooking time has been reduced, thereby improving the final food output.

FIG. 12B is a graph 1250 showing the power input over time to the heater in the traditional and predictive techniques. The power is shown in terms of pulse width modulation (PWM) as percent duty cycle. In traditional sous vide cooking, the heater 1252 is ramped up at approximately 100% duty cycle until the set point is achieved. At that point the duty cycle is reduce to approximately 25% to maintain the set point temperature. Using the disclosed predictive techniques, the heater 1254 can be ramped up at approximately 100% duty cycle until the fluid substantially reaches the higher set point temperature (e.g., 70° C.) with an acceptable tolerance. At that point the duty cycle is reduced to approximately 45% to maintain the set point temperature. The heater is then turned off (i.e., 0% duty cycle) to allow the fluid to cool to the desired fluid temperature, at which point the heater is increased and turned on at approximately 25% duty cycle to maintain the fluid and food item at the desired food temperature.

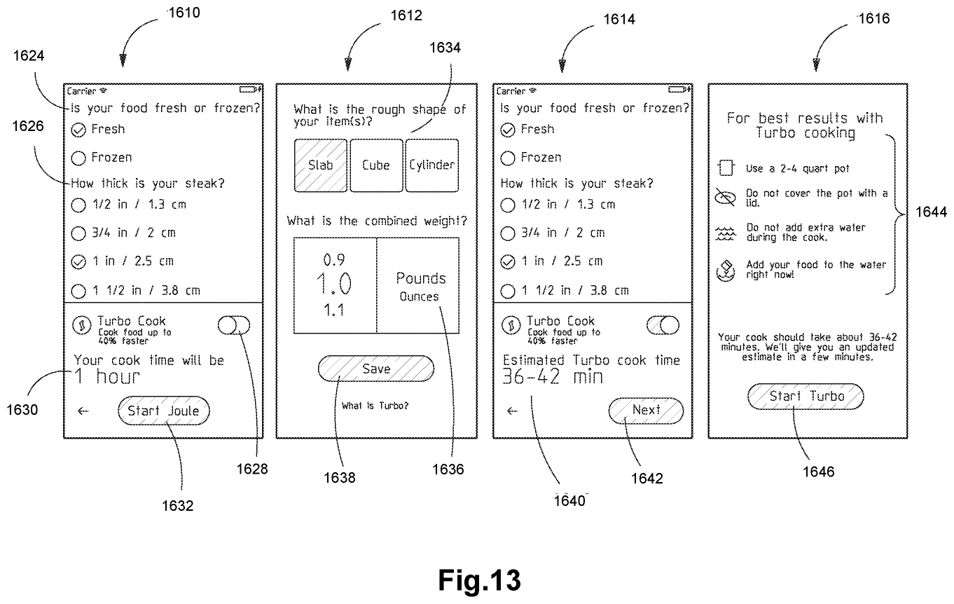

FIG. 13 illustrates a representative user interface for receiving various user input regarding the food item to be cooked. For example, in screen 1610 the user can select whether the food item is fresh or frozen with radio buttons 1624 or other suitable graphical control element. In the case where the food item is a steak, the user can input the thickness of the steak with radio buttons 1626. Using this initial input the system can provide a cook time estimate 1630 corresponding to a conventional sous vide cooking process. The user can start this process by selecting the start button 1632. However, screen 1610 also offers the user the option to use the disclosed predictive cooking techniques (e.g., Turbo Cook) by selecting toggle 1628. In this case, the user can input additional information on screen 1612. For example, the user can input the rough shape of the food item by selecting the corresponding button 1634. The user can also input the weight of the food item(s) with spinner 1636. These settings can be saved with the save button 1638, at which point screen 1614 can provide an updated estimated cook time 1640 using the disclosed predictive cooking techniques. Screen 1614 can include a next button 1642 to advance to the next screen. In some implementations, a screen 1016 can provide information and instructions 1644 prior to starting the cooking process with start button 1646.

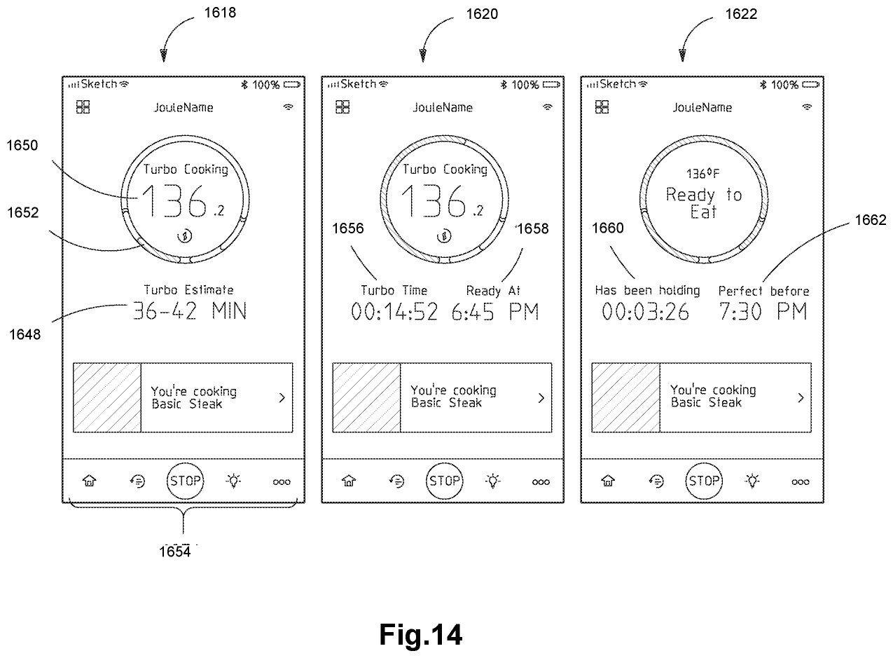

FIG. 14 illustrates representative status screens which indicate the current temperature and remaining cook time, for example. In an initial status screen 1618, the temperature 1650 is provided along with a progress indicator (e.g., circle) 1652. The estimated cook time 1648 is also provided. In some implementations, the various screens can include navigation controls 1654. In screen 1620, the time remaining 1656 is provided as well as a time of day 1658 at which the food item will be ready. Once the food item is ready, the system can maintain the item at the appropriate temperature until the user is ready to eat. Screen 1622 provides the length of time 1660 that the food item has been holding at the finished temperature and also provides a best before time 1662.

In some implementations, a representative cooking system can comprise a cooking device at least partially submergible in a container of fluid, the device including a heater and a temperature sensor, and at least one memory device storing instructions. The instructions can cause at least one processor to: receive information indicative of one or more characteristics of a food item to be cooked in the fluid; receive a desired food temperature; perform a control process; and to repeat the control process one or more times until the food temperature reaches the desired food temperature. The control process can include: sending instructions for controlling the heater, including information related to a heater set point temperature and a heater on time; obtaining a temperature measurement of the fluid from the temperature sensor; determining a measurement of power delivered to the heater; determining one or more constants related to one or more corresponding physical characteristics of at least one of the fluid and the container based on at least one of the temperature measurement and the measurement of power; determining a food temperature of the food item; and determining the heater set point temperature and the heater on time.

In some implementations, the set point temperature and the heater operation period can be determined by solving for the food item substantially reaching the desired food temperature while maintaining or subceeding a predetermined acceptable temperature gradient across the food item, and, after the heater operation period, the fluid cooling to substantially the desired food item temperature within a predetermined time period, and the food item substantially reaching the desired food temperature within the predetermined time period. The system can also wirelessly receive information related to the acceptable temperature gradient across the food item via a user device, such as a mobile phone or tablet. The system can provide feedback to the user device related to the predetermined acceptable temperature gradient. The set point temperature and the heater on time can be determined by solving for a fluid temperature that brings the food item to the desired food temperature at a user specified time while maintaining or subceeding a predetermined acceptable temperature gradient across the food item. The system can estimate at least one of a container type and a container size based on the one or more constants wherein the one or more process parameters can include at least one of a fluid volume value (c₁), a container thermal conductivity value (c₂), or an evaporative loss value (c₄). In some implementations, the system can receive at least one of a container type and a container size. The at least one of a container type and a container size can be received based on a name, number, or bar code positioned on the container. In some implementations, the system can detect when the food item is placed in the container based on a change in the temperature measurement and a change in the measurement of power. The system can identify if the food item is placed in the container before the fluid reaches the set point temperature and can adjust the set point temperature in response. The system can maintain the desired food temperature for a pasteurization time period selected based on the desired food temperature and the information indicative of one or more characteristics of the food item. The cooking device can include a pressure sensor and/or the system can receive geographic location information from the user device and estimate atmospheric pressure based on an altitude of the geographic location.

In some implementations, a representative cooking system can comprise a cooking device, the device including a heater and a temperature or pressure sensor, and at least one memory device storing instructions. The instruction can cause at least one processor to: receive information indicative of one or more characteristics of a food item to be cooked; receive a desired food temperature; and perform a process. The process can include sending instructions for controlling the heater, including a set point temperature, a heater operation period, or both a set point temperature and a heater operation period; obtaining a temperature measurement (T) related to cooking the food item from the sensor; determining a measurement of power (P) delivered to the heater; determining a fluid volume value (c₁), a container thermal conductivity value (c₂), or an evaporative loss value (c₄), by fitting a predetermined physical model to at least the temperature measurement (T) and the measurement of power (P); determining a food temperature (τ) of the food item; and determining the set point temperature, the heater operation period, or both the set point temperature and the heater operation period.

The system can include instructions for causing the processor to repeat the control process one or more times until the food temperature reaches the desired food temperature. In some implementations, the cooking device is at least partially submergible in a container of fluid. The set point temperature and the heater operation period can be determined by solving for a fluid temperature whereby the food item substantially reaches the desired food temperature while maintaining or subceeding a predetermined acceptable temperature gradient across the food item, and, after the heater operation period, the fluid cools to substantially the desired food item temperature within a predetermined time period, and the food item substantially reaches the desired food temperature within the predetermined time period. The cooking device can be at least partially submergible in a container of fluid, and the physical model can comprise Equation 1, where (F) is energy going into the food, (c₃) is an offset dependent on air temperature and dew point, and (H) is the specific humidity at the fluid surface. The physical model can be solved using one of a least squares method or a Kalman filter method. The food temperature (τ) can be determined with Equations 2-4, where τ(0≤r≤R, t≥t₀) is the food temperature, t₀ is when the food is added, α=k/(ρcₚ) is thermal diffusivity, k is thermal conductivity, ρ is density, cₚ is specific heat, 2R is the characteristic thickness, 0≤β<2 is the characteristic shape, h is surface heat transfer coefficient, and τ₀ is the initial food temperature. In some implementations, the set point temperature can be greater than the desired food temperature and the cooking device can be at least partially submergible in a container of fluid.

In some implementations, a representative method of heating a food item can comprise receiving information indicative of one or more characteristics of the food item to be cooked; receiving a desired food temperature; receiving information related to a predetermined acceptable temperature gradient across the food item; performing a process; and repeating the process one or more times until the food temperature reaches the desired food temperature. The process can include: sending instructions for controlling a heater positioned near the food item to be cooked, including information related to a set point temperature and a heater operation period; obtaining a temperature measurement relative to an environment proximate to the food item to be cooked; determining a measurement of power delivered to the heater; determining one or more process parameters related to one or more corresponding physical characteristics related to an environment surrounding a food item based on at least one of the temperature measurement and the measurement of power; determining an estimate of food temperature of the food item; and determining the set point temperature and the heater operation period by solving for a fluid temperature whereby the food item substantially reaches the desired food temperature while maintaining or subceeding a predetermined acceptable temperature gradient across the food item, and, after the heater operation period, the fluid cools to substantially the desired food item temperature within a predetermined time period, and the food item substantially reaches the desired food temperature within the predetermined time period.

In some implementations, the method is for heating a food item in a container of fluid and the determining the one or more process parameters can include determining at least one of a fluid volume value (c₁), a container thermal conductivity value (c₂), and an evaporative loss value (c₄) by fitting a physical model to at least the temperature measurement (T) and the measurement of power (P). The physical model can comprise Equation 1, where (F) is energy going into the food, (c₃) is an offset dependent on an ambient air temperature of the ambient atmosphere surrounding the cooking device and an ambient dew point of the ambient atmosphere surrounding the cooking device, and (H) is the specific humidity at the fluid surface.

In other implementations, the cooking appliance 702 can comprise convection air ovens, convection humidity or steam ovens, convection microwave ovens, heated mixers, heated blenders, and toasters. In these implementations, the container 704 is filled with a fluid 70, such as air with or without water vapor, and the cooking device 800 is integrated with the cooking appliance, for example as a heating element in a convection air oven, as a microwave generator in a convection microwave oven, or a heating element in the slot of a toaster. The cooking device 800 is in fluid communication with the liquid 70, being air in the cavity or slot, and as the cooking device 800 heats the liquid 70, the food item 72 can be cooked according to the predictive cooking methods disclosed herein. In these cases where the cooking device 800 is integrated with the cooking appliance 702, the size of the container 702 may be predetermined and set as a constant at manufacture, and does not need to be entered by the user.

In yet other implementations, the cooking appliance 702 can comprise a regular or pressure pot used with an induction cooker. In these implementations, the container 704 is filled with a fluid 70, such as saturated steam, and the cooking device 800 is the induction plate inducing heating of the regular or pressure port. The cooking device 800, being the induction cooker, is in energetic communication with the pot, and thereby the liquid 70, and as the cooking device 800 heats the liquid 70, the food item 72 can be cooked according to the predictive cooking methods disclosed herein.

In yet another implementation, the cooking device 800 for cooking a food item in a container 704 containing a fluid 70 includes a temperature sensor 811 for providing a temperature measurement, a pressure sensor 812 for providing an ambient pressure measurement, a second pressure sensor (not shown) for providing a container pressure measurement, and a humidity sensor (not shown) for providing a humidity measurement. The temperature sensor 811 may be suitable for providing a temperature measured of the fluid 70 and/or a heater 810 and/or a heating element of the heater 810. The cooking device 800 also includes at least one memory device 710 for storing executable instructions for operating the cooking device 800. The cooking device 800 also includes at least one processor 813 adapted to execute the executable instructions. The processor 813 controls a heater 810, optionally including a heating element, for heating the fluid 70 according to heater control information related to a set point temperature and a heater operation period. The set point temperature is the temperature to which the heater 810 seeks to heat the fluid 70 to. The heater operation period is the period of time for which the heater 810 is set to operate toward the set point temperature.

The processor 813 is adapted to receive food item information indicative of one or more characteristics of the food item to be cooked in the fluid, as well as a desired food temperature. Similarly, the processor 813 is adapted to obtain the temperature measurement from the temperature sensor 811, to obtain the ambient pressure measurement from the pressure sensor 812, to obtain the container pressure measurement from the second pressure sensor, and to obtain the humidity measurement from the humidity sensor.

The processor 813 is also adapted to facilitate determination of a measurement of power delivered to the heater based on the heater control information. For example, the processor 813 may provide the specifications of the heater 810 and a voltage, current, and/or duty cycle information to a cloud server (not shown) to determine the measurement of power delivered to the heater based on the heater control information. Alternatively, the cloud server may retain and/or access this information from previous determinations. In a further alternative, the processor 813 may perform the determination of the measurement of power delivered based on the heater control information.

The processor 813 is adapted to facilitate determination of one or more process parameters related to one or more corresponding physical characteristics of at least one of the fluid and the container based on at least one of the temperature measurement and the measurement of power. For example, the processor 813 may provide the temperature measurement, the measurement of power, the ambient pressure measurement, the container pressure measurement, and/or the humidity measurement to a cloud server to determine the one or more process parameters. Alternatively, the cloud server may retain and/or access this information from previous determinations. In a further alternative, the processor 813 may perform the determination of the one or more process parameters locally.

The processor 813 is adapted to facilitate determination of a food temperature of the food item based on the one or more process parameters, the temperature measurement, and/or the measurement of power. For example, the processor 813 may provide the one or more process parameters, the temperature measurement, the measurement of power, the ambient pressure measurement, the container pressure measurement, and/or the humidity measurement to a cloud server to determine the food temperature. Alternatively, the cloud server may retain and/or access this information from previous determinations. In a further alternative, the processor 813 may perform the determination of the food temperature locally.

The processor 813 is adapted to facilitate determination of updated heater control information based on the food temperature, the one or more process parameters, the temperature measurement, and/or the measurement of power. For example, the processor 813 may provide the food temperature, the one or more process parameters, the temperature measurement, the measurement of power, the ambient pressure measurement, the container pressure measurement, and/or the humidity measurement to a cloud server to determine the updated heater control information. Alternatively, the cloud server may retain and/or access this information from previous determinations. In a further alternative, the processor 813 may perform the determination of the updated heater control information locally.

The processor 813 is also adapted to control the heater 810 according to the updated heater control information until the food temperature substantially reaches the desired food temperature.

The processor 813 is also adapted to receive container information indicative of at least one of a container type and a container size of the container 704. The processor 813 is adapted to facilitate determination of the one or more process parameters at least based on the container information. The container information may be included in a name, number, or bar code positioned on the container 704.

In some implementations, the cooking device 800 may include the container 704. In some implementations the cooking device 800 includes the heater 810.

It will be appreciated that the methods of operation of the processor-based predictive cooking system described above may equally apply to other cooking devices such as a slow cooker.

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

In FIG. 7, network 712 can be a local area network (LAN) or a wide area network (WAN), but can also be other wired or wireless networks. Network 712 may be the Internet or some other public or private network. Client computing devices 706 can be connected to network 712 through a network interface, such as by wired or wireless communication. The techniques disclosed herein can be implemented on one or more processors. For example, the system can be implemented on one or more networked processors 708, the cooking device processor 813, a processor of an associated client computing device 706, or any suitable combination thereof.

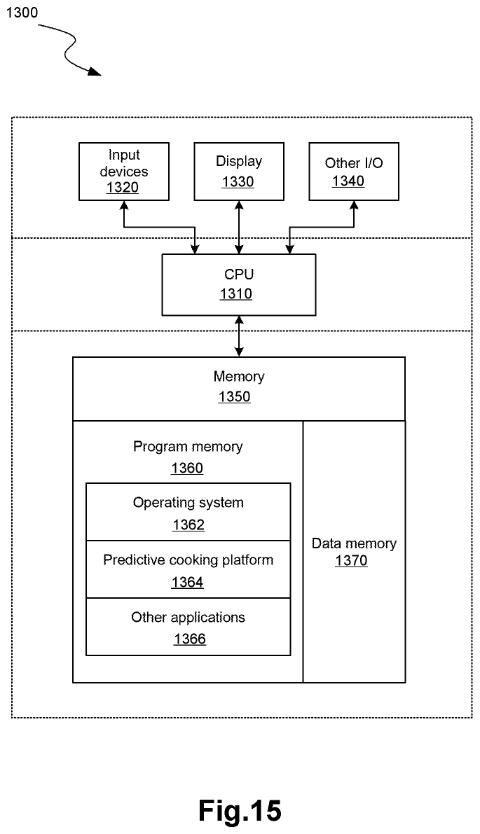

Several implementations are discussed below in more detail in reference to the figures. Turning now to the figures, FIG. 15 is a block diagram illustrating an overview of devices on which some implementations of the disclosed technology can operate. The devices can comprise hardware components of a device 1300 that determines optimal cooking programs. Device 1300 can include one or more input devices 1320 that provide input to the CPU (processor) 1310, notifying it of actions. The actions are typically mediated by a hardware controller that interprets the signals received from the input device and communicates the information to the CPU 1310 using a communication protocol. Input devices 1320 include, for example, a mouse, a keyboard, a touchscreen, an infrared sensor, a touchpad, a wearable input device, a camera- or image-based input device, a microphone, or other user input devices.

CPU 1310 can be a single processing unit or multiple processing units in a device or distributed across multiple devices. CPU 1310 can be coupled to other hardware devices, for example, with the use of a bus, such as a PCI bus or SCSI bus. The CPU 1310 can communicate with a hardware controller for devices, such as for a display 1330. Display 1330 can be used to display text and graphics. In some examples, display 1330 provides graphical and textual visual feedback to a user. In some implementations, display 1330 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 1340 can also be coupled to the processor, such as a network card, video card, audio card, USB, FireWire or other external device, camera, printer, speakers, CD-ROM drive, DVD drive, disk drive, or Blu-Ray device.

In some implementations, the device 1300 also includes a communication device capable of communicating wirelessly or wire-based with a network node. The communication device can communicate with another device or a server through a network using, for example, TCP/IP protocols. Device 1300 can utilize the communication device to distribute operations across multiple network devices.

The CPU 1310 can have access to a memory 1350. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 1350 can include program memory 1360 that stores programs and software, such as an operating system 1362, predictive cooking platform 1364, and other application programs 1366. Memory 1350 can also include data memory 1370 that can include start time, completion time, user preferences such as tenderness of meat, etc., which can be provided to the program memory 1360 or any element of the device 1300.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

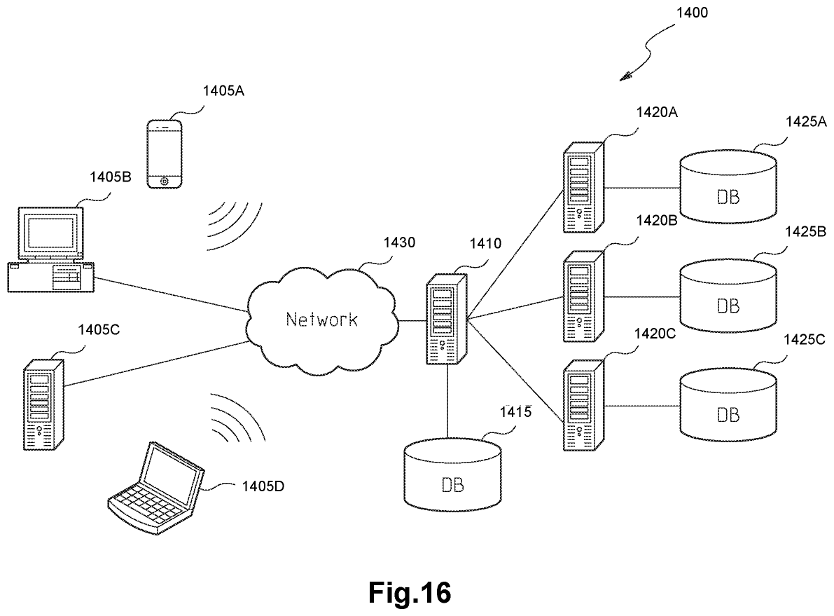

FIG. 16 is a block diagram illustrating an overview of an environment 1400 in which some implementations of the disclosed technology can operate. Environment 1400 can include one or more client computing devices 1405A-D, examples of which can include device 1300. Client computing devices 1405 can operate in a networked environment using logical connections through network 1430 to one or more remote computers, such as a server computing device 1410.

In some implementations, server computing device 1410 can be an edge server that receives client requests and coordinates fulfillment of those requests through other servers, such as servers 1420A-C. Server computing devices 1410 and 1420 can comprise computing systems, such as device 700. Though each server computing device 1410 and 1420 is displayed logically as a single server, server computing devices can each be a distributed computing environment encompassing multiple computing devices located at the same or at geographically disparate physical locations. In some implementations, each server computing device 1420 corresponds to a group of servers.

Client computing devices 1405 and server computing devices 1410 and 1420 can each act as a server or client to other server/client devices. Server 1410 can connect to a database 1415. Servers 1420A-C can each connect to a corresponding database 1425A-C. As discussed above, each server 1420 can correspond to a group of servers, and each of these servers can share a database or can have their own database. Databases 1415 and 1425 can warehouse (e.g., store) information such as start time, completion time, and user preferences. Though databases 1415 and 1425 are displayed logically as single units, databases 1415 and 1425 can each be a distributed computing environment encompassing multiple computing devices, can be located within their corresponding server, or can be located at the same or at geographically disparate physical locations.

Network 1430 can be a local area network (LAN) or a wide area network (WAN), but can also be other wired or wireless networks. Network 1430 may be the Internet or some other public or private network. Client computing devices 1405 can be connected to network 1430 through a network interface, such as by wired or wireless communication. While the connections between server 1410 and servers 1420 are shown as separate connections, these connections can be any kind of local, wide area, wired, or wireless network, including network 1430 or a separate public or private network.

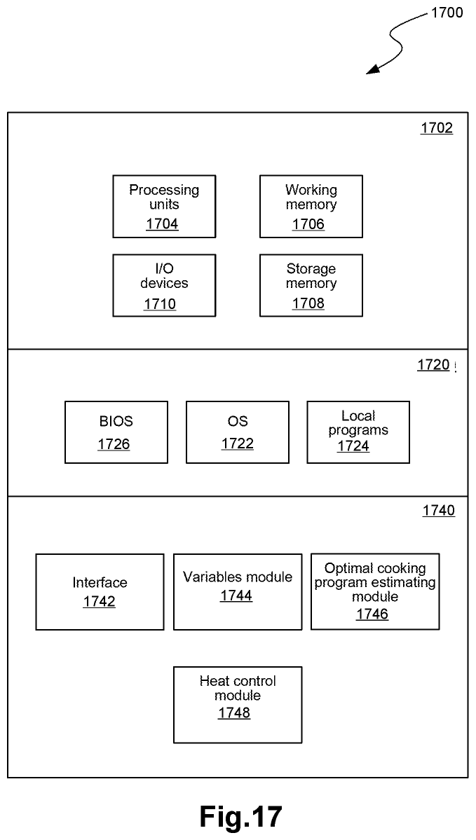

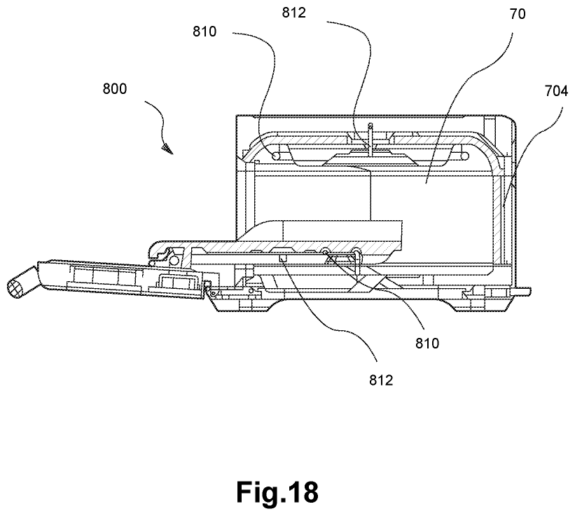

FIG. 17 is a block diagram illustrating components 1500 which, in some implementations, can be used in a system employing the disclosed technology. The components 1500 include hardware 1502, general software 1520, and specialized components 1540. As discussed above, a system implementing the disclosed technology can use various hardware, including processing units 1504 (e.g., CPUs, GPUs, APUs, etc.), working memory 1506, storage memory 1508, and input and output devices 1510. Components 1500 can be implemented in a client computing device such as client computing devices 1405 or on a server computing device, such as server computing device 1410 or 1420.

General software 1520 can include various applications, including an operating system 1522, local programs 1524, and a basic input output system (BIOS) 1526. Specialized components 1540 can be subcomponents of a general software application 1520, such as local programs 1524. Specialized components 1540 can include variables module 1544, optimal cooking program estimating module 1546, heat control module 1548, and components that can be used for transferring data and controlling the specialized components, such as interface 1542. In some implementations, components 1500 can be in a computing system that is distributed across multiple computing devices or can be an interface to a server-based application executing one or more of specialized components 1540.

Those skilled in the art will appreciate that the components illustrated in FIGS. 15-17 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described below.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

1. A cooking device comprising:
one or more heating elements for heating a fluid; and
a control system configured to:
control the one or more heating elements for a first period of time in order to heat the fluid to a first temperature;
control the one or more heating elements for a second period of time such that the temperature of the fluid falls to a second temperature; and
control the one or more heating elements for a third period of time to increase power supplied to the one or more heating elements relative to power supplied to the one or more heating elements during the second period of time.

2. The cooking device according to claim 1, wherein the increase in power supplied to the one or more heating elements for the third period of time results in one of:
increasing the temperature of the fluid to a third temperature which is greater than the second temperature; or
maintaining the temperature of the fluid at the second temperature during the third period of time.

3. The cooking device according to claim 1 or 2 further comprising an input device for receiving input information, wherein the control system is configured to determine the first, second and third period of time and the first and second temperature based on the input information.

4. The cooking device according p3, wherein the input information comprises an original cooking time and an extended cooking time, wherein the original cooking time is not less than a sum of the first period of time and the third period of time, and the extended cooking time is equal to a sum of the first, second and third period of time.

5. The cooking device according to any one of claims 1 to 4, further comprising a sensor coupled to the control system, wherein the sensor is configured to detect a temperature of the fluid and transmit a signal representing the detected temperature to the control system.

6. The cooking device according to any one of claims 1 to 5, wherein the cooking device is one of a vessel cooker comprising a vessel in which the fluid is heated; an induction cooker; and a sous vide device.

7. The cooking device according to any one of claims 1 to 6, the control system is further configured to control the one or more heating elements to operate at one or more preheating temperatures to preheat the fluid for a respective one or more periods of time.

8. A control system of a cooking device, the cooking device comprising one or more heating elements for heating a fluid, wherein the control system is configured to:
control the one or more heating elements for a first period of time in order to heat the fluid to a first temperature;
control the one or more heating elements for a second period of time such that the temperature of the fluid falls to a second temperature; and
control the one or more heating elements for a third period of time to increase power supplied to the one or more heating elements relative to power supplied to the one or more heating elements during the second period of time.

9. The control system according to claim 8, wherein the increase in power supplied to the one or more heating elements for the third period of time results in one of:
increasing the temperature of the fluid to a third temperature which is greater than the second temperature; or
maintaining the temperature of the fluid at the second temperature during the third period of time.

10. The control system according to claim 8 or 9, wherein the control system is configured to determine the first, second and third period of time and the first, second and third temperature based on an input information received from an input device of the cooking device.

11. The control system according to claim 10, wherein the input information comprises an original cooking time and an extended cooking time, wherein the original cooking time is greater than a sum of the first period of time and the third period of time, and the extended cooking time is equal to a sum of the first, second and third period of time.

12. The control system according to any one of claims 8 to 11, wherein the control system is configured to receive, from a sensor, a signal representing a temperature of the fluid and control the one or more heating elements based on the received signal.

13. The control system according to any one of claims 8 to 12, wherein the cooking device is one of a vessel cooker comprising a vessel configured to hold the fluid; an induction cooker; and an sous vide device.

14. The control system according to any one of claims 8 to 13, the control system is further configured to control the one or more heating elements to operate at one or more preheating temperatures to preheat the fluid for a respective one or more periods of time.

15. A method of controlling a cooking device, the cooking device comprising one or more heating elements for heating a fluid, the method comprising:
controlling the one or more heating elements for a first period of time in order to heat the fluid to a first temperature;
controlling the one or more heating elements for a second period of time such that the temperature of the fluid falls to a second temperature; and
controlling the one or more heating elements for a third period of time to increase power supplied to the one or more heating elements relative to power supplied to the one or more heating elements during the second period of time.

16. The method according to claim 15, wherein the increase in power supplied to the one or more heating elements for the third period of time results in one of:
increasing the temperature of the fluid to a third temperature which is greater than the second temperature; or
maintaining the temperature of the fluid at the second temperature during the third period of time.

17. The method according to claim 15 or 16, further comprising:
receiving, by the control system from a sensor, a signal representing a temperature of the fluid; and
controlling, by the control system, the one or more heating elements based on the received signal.

18. The method according to any one of claims 15 to 17, further comprising:
receiving, from an input device, input information; and
determining, by the control system, the first, second and third period of time and the first, second temperature based on the input information.

19. The method according to claim 18, wherein the input information comprises an original cooking time and an extended cooking time, wherein the original cooking time is greater than a sum of the first period of time and the third period of time, and the extended cooking time is equal to a sum of the first, second and third period of time.

20. The method according to any one of claims 15 to 19, wherein the cooking device is one of a vessel cooker comprising a vessel configured to hold the fluid; an induction cooker; and a sous vide device.

21. The method according to any one of claims 15 to 20, further comprising controlling, by the control system, the one or more heating elements to operate at one or more preheating temperatures to preheat the fluid for a respective one or more periods of time.
